(19) United States
(12) Patent Application Publication
(10) Pub. No.: US 2011/0255076 A1
(43) Pub. Date: Oct. 20, 2011

(54) METHOD FOR DETERMINING A PARTICLE CONCENTRATION AND MEASURING APPARATUS

(75) Inventor: Uwe MELCHER, Ottendorf-Okrilla (DE)

(73) Assignee: SICK ENGINEERING GMBH, Ottendorf-Okrilla (DE)

(21) Appl. No.: 13/075,235

(22) Filed: Mar. 30, 2011

(30) Foreign Application Priority Data
Apr. 15, 2010 (EP) 10160039.3

(51) Int. Cl. G01N 21/00

(52) U.S. Cl. 356/73

(57) ABSTRACT

To provide an improved method and an improved measuring apparatus for determining a particle concentration with which the disadvantages of the transmission measurement principle and of the scattered light measurement principle can be compensated to a certain degree to achieve a higher precision in the particle concentration measurement, a method and a measuring apparatus are proposed in accordance with the invention, wherein
measured value pairs are determined at specific times over a time period, with the measured value pairs each comprising a measured extraction value in accordance with the principle of transmitted light measurement and a corresponding measured scattered light measurement in accordance with the principle of scattered light measurement;
the measured values are stored;
a correction value is determined using the stored measured value pairs in a measured value preparation phase subsequent to the time period;
the measured extinction value then currently determined after this is corrected using the correction value;
and the then current particle concentration is determined from the thus corrected measured extinction value.

The invention relates to a method for determining a particle concentration and to a measuring apparatus for carrying out the method.

Such measuring apparatus serve, for example, for determining the concentration of dust particles or sooty particles in industrial flue gas stacks. Two measurement principles are generally used in the determining of particle concentrations. One is the transmission measurement in which the attenuation of the transmitted light (extinction) is measured; and the other is the scattered light measurement in which the portion of the transmitted light is detected which is scattered out of the transmitted light direction by the particles and is scattered in the direction of the light receiver.

Disadvantages of transmissiometers are small zero point precision and a weak measuring effect. The scattered light measurement is therefore in particular suitable for determining comparatively small particle concentrations, whereas the extinction measurement is more suitable for higher particle concentrations. The transmissiometers are furthermore not as sensitive to irregular dust distribution in the passage due to the measurement path extending transversely through the gas passage. The measuring effect in transmissiometers is, however, in particular so weak with small measurement paths and the very small dust concentrations customary today behind modern filters that the resolution and precision is frequently no longer up to the demands. The apparatus usually have an insufficient zero point stability which is caused by a number of external influences such as distance change, optical maladjustment, thermal deformation and contamination of the optical interfaces.

The scattered light measuring apparatus, in contrast, have a much higher resolution and good zero point precision. The measurement is, however, limited to a relatively small measuring volume which is usually located close to the passage wall, that is so-to-say only at one point of the cross-sectional surface of a gas passage. With an irregular dust distribution, the measuring process will therefore tend not to deliver representative values. Despite this disadvantage, the spread of scattered light measuring apparatus is increasing considerably because the transmissiometers in their classical form simply have insufficient resolution and precision.

A measuring apparatus is known from DE 10 2005 025 181 A1 which can use both measuring processes independently of the respective other measuring process in one apparatus. The respective measured values of the different measuring processes are output independently of one another. Since either the one or the other measuring process is used, it is no great advantage to the user because he must decide whether he takes the measured result from the transmission measurement or that from the scattered light measurement, with the respective advantages and disadvantages of the individual measuring processes and corresponding uncertainties in the measured value. It is even the case that, with different measured results which also arise due to the different physical principles of the measuring processes, there is a need for explanation when the measured results differ from one another.

Starting from this prior art, it is the object of the invention to provide an improved method and an improved measuring apparatus with which the disadvantages of the transmission measurement principle and of the scattered light measurement principle can be compensated to a certain degree to achieve a higher precision in the particle concentration measurement.

This object is satisfied by a method having the features of claim 1 and by a measuring apparatus having the features of claim 6.

The method in accordance with the invention comprises the following steps:
measured value pairs are determined at specific times over a time period, with the measured value pairs each comprising a measured extraction value in accordance with the principle of transmitted light measurement and a corresponding measured scattered light measurement in accordance with the principle of scattered light measurement;
the measured value pairs are stored;
a correction value is determined using the stored measured value pairs in a measured value preparation phase subsequent to the time period;
the measured extinction value then currently determined after this is corrected using the correction value;
and the then current particle concentration is determined from the thus corrected measured extinction value.

The essential recognition comprises the fact of now linking both measurement principles with one another, whereby the advantages of the scattered light measurement principle are utilized for the measured result of the extinction measuring process in order ultimately to obtain a measured value which has a higher precision.

This recognition has two underlying postulates which the inventors have set up:
The transmission measurement process is more representative and so of a higher value so that the transmission should be declared the primary measured variable;
The scattered light measurement with e.g. the good zero point precision should be utilized as an auxiliary parameter in order e.g. to improve the poor zero point stability of the transmission.

Using these postulates, the user is already relieved of the decision of which measurement process he should prioritize for his application.

The invention can in particular be used to special advantage in countries which are traditionally still focused strongly on the transmission process or the measured variables derived therefrom due to their legislation.

The method in accordance with the invention and the measuring apparatus in accordance with the invention overall deliver measured results for the particle concentration which have a higher precision than the individual results which can be determined solely by the extinction measurement or solely by the scattered light measurement in that namely the individual results are combined with one another in the manner in accordance with the invention such that the overall result is better than the individual results.

Furthermore, the measuring apparatus in accordance with the invention cannot only be used in the manner in accordance with the invention, but rather also still in the traditional manner, namely for the extinction measurement alone or for the scattered light measurement alone.

Since the transmission process in particular has a poor zero point stability, the correction value is advantageously a zero point deviation, with the correction values being determined from a regression characteristic for the extinction prepared from the stored measured value pairs as a function of the scattered light. The zero point correction of the transmission passage via the measured variable scattered light can also be used to save an otherwise necessary contamination measuring apparatus because contaminations have the effect of a zero point displacement of the optical measured value extinction. Mechanical pivot lenses which can be pivoted into the beam path for the contamination measurement can thus e.g. be saved. Other compensation processes for compensating a contamination can also be dispensed with.

In a further development of the invention, the measured value preparation phase is cyclically repeated to update the correction value. The last determined correction value is used for determining the particle concentration between the measured value preparation phases, that is during the time period in which the measured data are detected and the measured value pairs are stored, until a new correction value has been determined in a new measured value preparation phase. The most up-to-date correction value is thus always available for the correction. In practice, the time periods in which the measured value pairs are detected and which are used for the correction are selected as relatively long so that a sufficient statistical basis for the correction can be used.

In principle, it would also be conceivable that, if sufficient resources are available in the correction unit in normal operation, the processing of the measured values also takes place in real time for a past time period. The correction value would then not be refreshed cyclically, but constantly.

In a further development of the invention, the measured extinction values and the measured scattered light values can be preprocessed before the storing, in particular by averaging and/or filtering.

The measured value preparation is relatively CPU intensive and so time-consuming. It would therefore require relatively powerful processors if one were to want to carry out the exhaustive measured value preparation in real time. If, however, it takes place during periodically carried out self-tests, this time can be used in which the measuring device anyway does not output any measured values.

With respect to the apparatus, the object is satisfied by a corresponding measuring apparatus for carrying out the method. The measuring apparatus in accordance with the invention includes a light transmitter and has a light receiver with which a portion of the transmitted light attenuated by particles can be detected in an extinction measurement and has as a light receiver with which a portion of the transmitted light can be detected in a scattered light measurement, said portion having been scattered at the particles, and includes an evaluation unit which has a measured value memory in which both the determined measured extinction values and the measured scattered light values can be stored over a time period as measured value pairs and which has a correction unit in which a correction value for the measured extinction values can be determined by means of the stored measured value pairs and in which the then currently determined measured extinction values can be corrected using the correction value for determining a particle concentration value.

The correction value advantageously has means for determining a zero point deviation which can be determined from a regression characteristic for the extinction as a function of the scattered light and this zero point deviation forms the correction value.

The invention will be explained in detail in the following with reference to an embodiment and to the drawing. There are shown in the drawing:

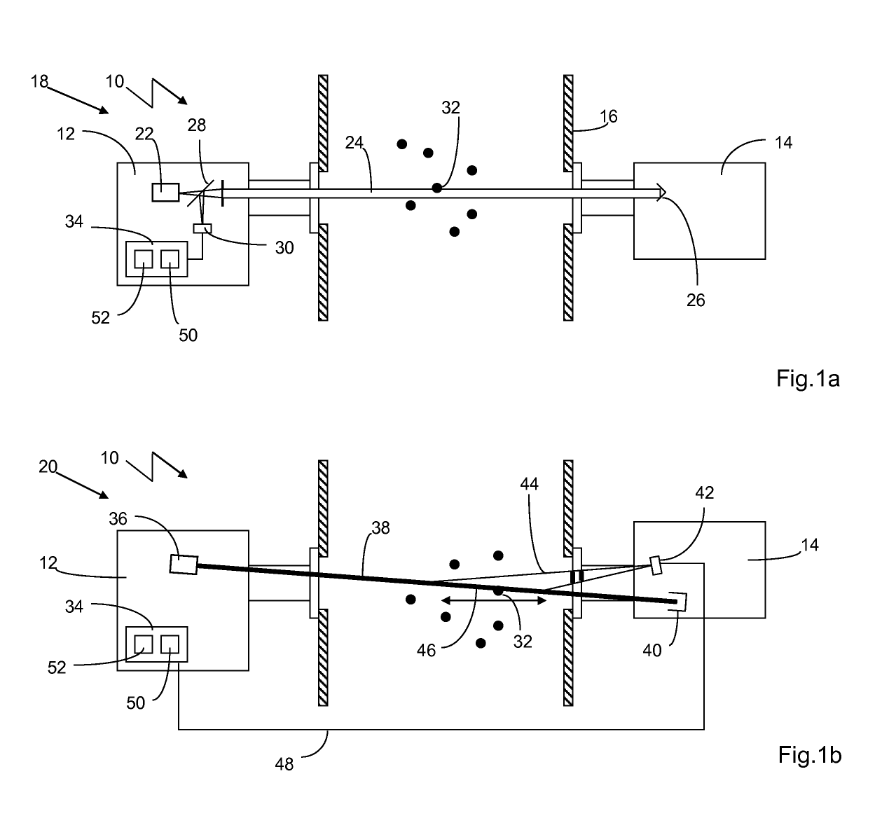

FIGS. 1a and 1b a measuring apparatus in accordance with the invention;

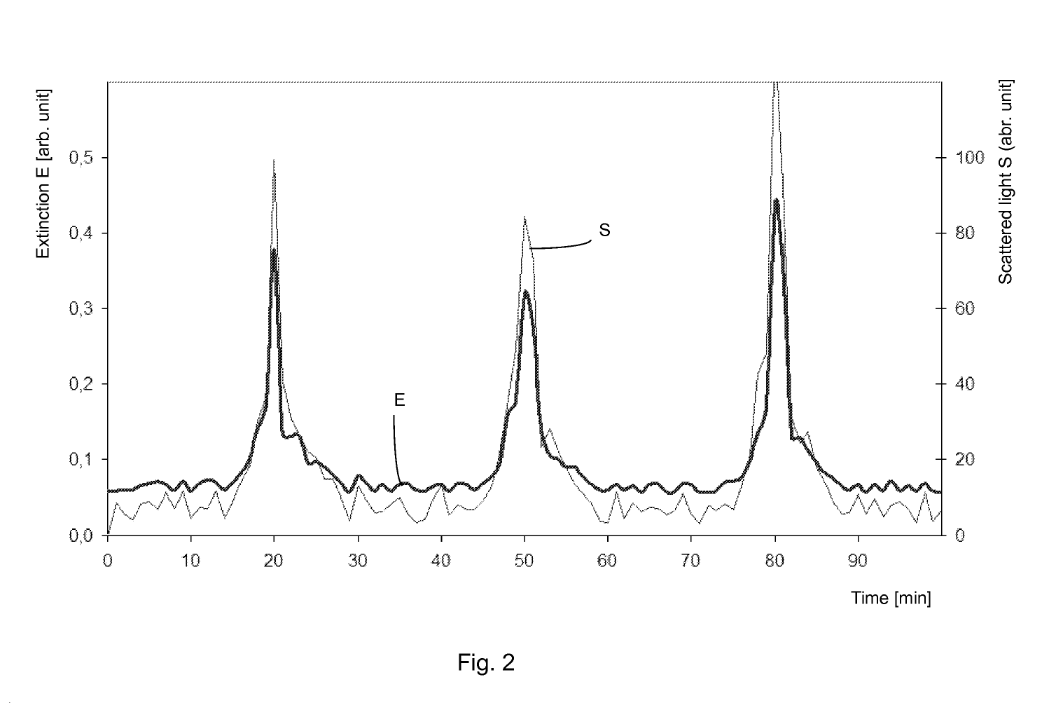

FIG. 2 a diagram for illustrating a typical curve of the measured extinction value and of the measured scattered light value over time; and

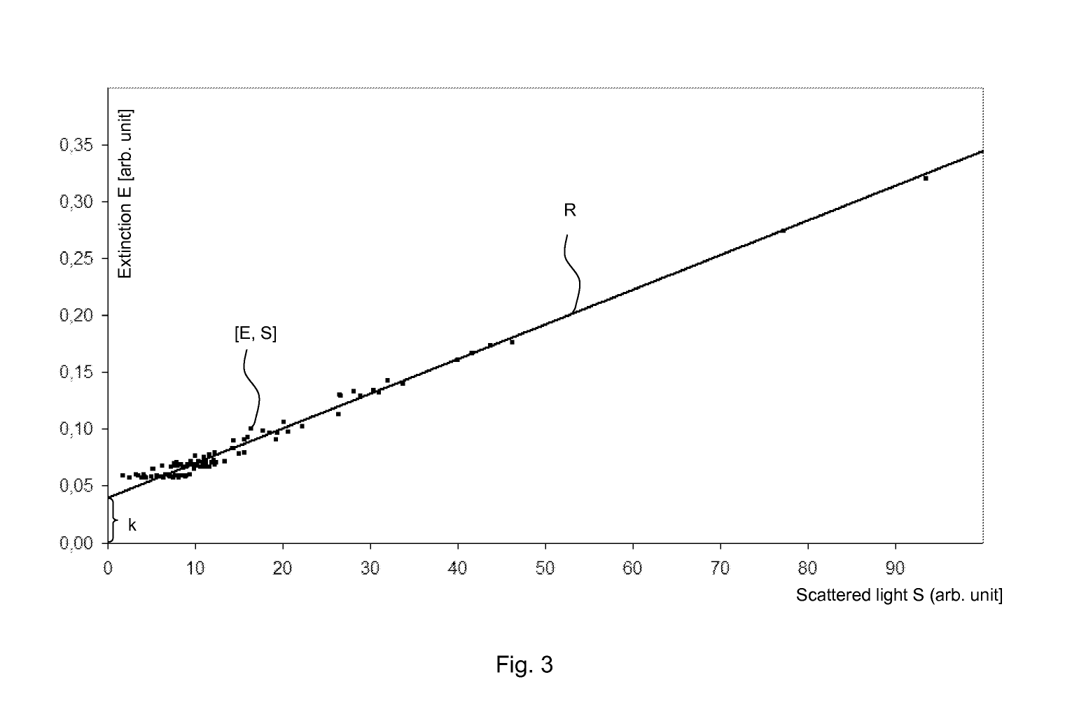

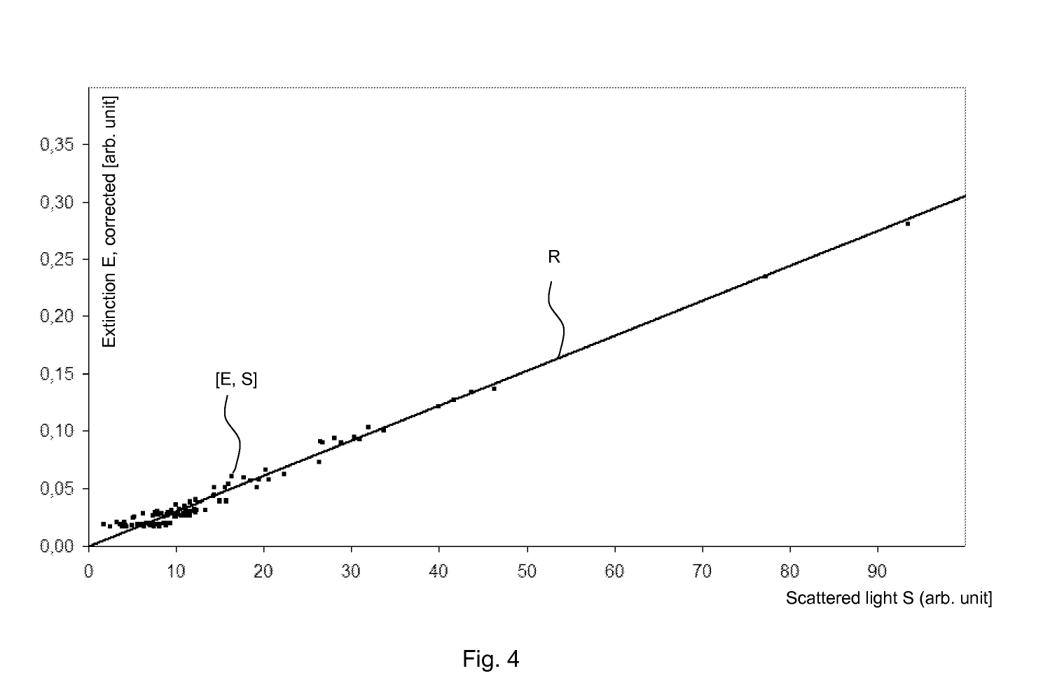

FIGS. 3 and 4 in each case a diagram in which the extinction is entered as a function as the scattered light, with and without a zero point correction.

A measuring apparatus 10 in accordance with the invention is described in detail with respect to its hardware in DE 102005025181 A1. It has a transceiver unit 12 and a reflector/scattered light receiver unit 14 which is arranged on opposite sides of an industrial flue gas stack 16 such that transmitted light beams of the transceiver unit 12 pass through the stack 16 and are incident on the reflector/scattered light receiver unit 14.

The measuring apparatus 10 in this respect includes a transmissiometer 18 which is shown schematically in FIG. 1a and a scattered light measuring device 20 which is shown in FIG. 1b. Despite the separate representation in these two Figures, both devices 18 and 20 are part of the measuring apparatus 10 in accordance with the invention so that both devices in this embodiment are integrated in the one transceiver unit 12 and the one reflector/scattered light receiver unit 14.

The transmissiometer 18 has a first light transmitter 22, preferably an LED having an optical transmission system whose transmitted light beam 24 shines through the stack 16, is incident onto a reflector 26 of the reflector/scattered light receiver unit 14, is reflected back on itself from there, is incident on a beam splitter 28 in the transceiver unit 12 and is directed from it onto a first light receiver 30. An attenuation of the transmitted light 24 (extinction) by particles 32 in the stack 16 can thus be measured using the receiver 30, for which purpose the received signals of the light receiver 30 corresponding to the received light are evaluated in an evaluation unit 34. In this manner, measured extinction values are obtained from which in turn a particle concentration can be determined.

The scattered light measuring device 20 has a second light transmitter 36, preferably a laser, whose transmitted light 38 likewise passes through the stack 16 and is absorbed by an absorber 40 in the reflector/scattered light receiver unit 14. A second light receiver 42 is arranged in the reflector/scattered light receiver unit 14 and its received light lobe 44 intersects the transmitted light beam 38 in a measuring volume 46 so that the second light receiver 42 can pick up any scattered light of the particles 32 which is scattered in the direction of the light receiver 42. The corresponding received signals are supplied via a line 48 to the evaluation unit 34 so that measured scattered light values are available in the evaluation unit 34.

FIG. 2 shows typical signal curves of the measured extinction value E and of the measured scattered light value S at an industrial flue gas stack over a specific period of time. The regular peak values are usually caused by cleaning cycles of the dust filters which are provided in such a stack.

The evaluation unit 34 has a measured value memory 50 in which the determined measured extinction values and the determined measured scattered light values can be stored as well as a correction unit 52. The functions of the measured value memory 50 and of the correction unit 52 will be described in detail in the following when the method in accordance with the invention is described.

The method in accordance with the invention runs as follows:

First, a respective measured value pair [E, S] is picked up at individual points in time over a larger time period, for example over eight house, with a measured value pair each comprising a measured extinction value E and a measured scattered light value S. A plurality of measured value pairs [E, S] are obtained in this manner. These measured value pairs are stored in the measured value memory 50. This time period is then followed by a measured value preparation phase in which a correction value is determined using the stored measured value pairs in the correction unit 52, as described in the following.

A regression characteristic R for the extinction E is calculated as a function of the scattered light S, as is shown graphically in FIG. 3. FIG. 3 shows the extinction E as a function of the scattered light S, that is the stored measured values pairs as dots in this diagram. A regression characteristic R is found by mathematical preparation of the measured value pairs [E, S] and a correction value k is determined which corresponds to the deviation from the zero point.

The determination of the correction value k in this manner is based on the following underlying physical observations:

a) The extinction derived from the optical measured value “transmission” behaves in a linear fashion to the concentration and in a linear fashion to the absorption path with stationary dust properties;
b) The optical measured value “scattered light” likewise behaves in a linear fashion to the concentration with stationary dust properties;
c) Each dust measurement has a certain dynamic characteristic in the measured signal; It also arises e.g. in that an increased dust charge is caused when cleaning filters. However, natural noise and fluctuations due to load change and other process influences also occur; and
d) When dust is no longer present in the gas passage, that is a so-called—“smoke-free measurement path” is present in the gas passage, the scattered light measuring process indicates zero. There are then also no longer any influences due to irregular dust distribution in the gas passage.

The determination of the correction value k via a regression characteristic and the definition of the correction value as a zero point deviation are thus justified.

This correction value k, that is the zero point error of the extinction, is then used after the measured value preparation phase in the further course of the measurement as compensation for the extinction. The then current measured extinction value is therefore taken for the final determination of the particle concentration and the zero point error is compensated using the correction value k. The particle concentration is then determined from this corrected extinction value and indicated at a suitable display. This correction value k is used for determining the particle concentration for so long until the correction value k has been updated.

The updating of the correction value k takes place cyclically. For this purpose, the then currently valid correction value k is used for determining the particle concentration over the next time period following the past measured value preparation phase up to the next measured value preparation phase. In the measured value preparation phase then carried out repeatedly with the newly picked up and newly stored measured value pairs, a new correction value is determined in the same manner using new measured value pairs and this then current correction value is then used for the further determination of the particle concentration up to a new measured value preparation phase.

In a further development which is very relevant to practice, the cyclically determined correction values are filtered for plausibility and optionally also introduced into the correction in weighted form to be able largely to eliminate one-time disturbances. A new correction value can thus e.g. be composed of the two last correction values in a certain weight ratio, e.g. 20% from the correction value determined from the last-but-.one measurement preparation phase and 80% from the correction value determined from the last measurement preparation phase.

1. A method of determining a particle concentration, wherein
measured value pairs are determined at specific times over a time period, with the measured value pairs each comprising a measured extraction value in accordance with the principle of transmitted light measurement and a corresponding measured scattered light measurement in accordance with the principle of scattered light measurement;
the measured values are stored;
a correction value is determined using the stored measured value pairs in a measured value preparation phase subsequent to the time period;
the measured extinction value then currently determined after this is corrected using the correction value;
and the then current particle concentration is determined from the thus corrected measured extinction value.

2. A method in accordance with claim 1, characterized in that the correction value is a zero point deviation and the correction value is determined from a regression characteristic for the extinction prepared from the stored measured value pairs as a function of the scattered light.

3. A method in accordance with claim 1, characterized in that the measured value preparation phase is repeated cyclically for updating the correction value and the last determined correction value is used for determining the particle concentration during the time period until a new correction value is determined in a new measured value preparation phase.

4. A method in accordance with claim 1, characterized in that the measured extinction values and the measured scattered light values are preprocessed before the storing, in particular by averaging and/or filtering.

5. A method in accordance with claim 1, characterized in that the measured value preparation takes place during periodically carried out self-tests.

6. A measuring apparatus for determining the particle concentration within a measurement volume accordance with the principle of transmitted light measurement having a light transmitter and having a light receiver with which a portion of the transmitted light attenuated by particles can be detected in an extinction measurement and having a light receiver with which a portion of the transmitted light can be detected in a scattered light measurement, said portion having been scattered at the particles, and having an evaluation unit which has a measured value memory in which both the determined measured extinction values and the measured scattered light values can be stored over a time period as measured value pairs and which has a correction unit in which a correction value for the measured extinction values can be determined by means of the stored measured value pairs and in which the then currently determined measured extinction values can be corrected using the correction value for determining a particle concentration value.

7. A measuring apparatus in accordance with claim 6, characterized in that the correction unit has means for determining a zero point correction value which can be determined from a regression characteristic for the extinction as a function of the scattered light and this zero point correction forms the correction value.
